(19) United States
(12) Patent Application Publication
(10) Pub. No.: US 2009/0295116 A1
(43) Pub. Date: Dec. 3, 2009

(54) STEP ASSEMBLY FOR UTILITY CART

(76) Inventor: Sharon Neeley, Ravenswood, WV (US)

Correspondence Address: JAY M. SCHLOFF, 6960 Orchard Lake Road, Suite 315, West Bloomfield, MI, 48322, US

(21) Appl. No.: 12/472,574

(22) Filed: May 27, 2009

Related U.S. Application Data
(60) Provisional application No. 61/130,055, filed on May 28, 2008.

(51) Int. Cl. B60R 3/02

(52) U.S. Cl. 280/166

(57) ABSTRACT

A step assembly for a utility cart. The step assembly includes a platform member and a pair of support legs. The platform member is capable of being hingedly attached to a portion of the utility cart for facilitating movement of the step assembly between an operative position and a collapsed position of the step assembly. The pair of support legs is hingedly attached to the platform member at a peripheral edge portion of the platform member.

### CROSS-REFERENCE TO RELATED APPLICATIONS

The present disclosure claims priority under 35 United States Code, Section 119 on the U.S. Provisional Patent Application No. 61/130,055, filed on May 28, 2008, the disclosure of which is incorporated by reference.

### FIELD OF THE DISCLOSURE

The present disclosure generally relates to carts, and more particularly, to a step assembly for a cart, such as a utility cart for facilitating in reaching otherwise inaccessible elevated locations at shopping facilities, such as grocery stores, retail stores, shopping marts, supermarkets, department stores and the like.

### BACKGROUND OF THE DISCLOSURE

In shopping facilities such as grocery stores, retail stores, supermarkets, department stores, shopping marts and the like (hereinafter referred to as “stores”), articles are stacked in a storage area. Common examples of the articles may include groceries, pharmacy products, pet supplies, clothes and other such products. These articles may be transported to a display area, such as vertically extending shelves from where a customer/user may fetch the articles. Once all or most of the articles stacked in display areas are exhausted or purchased by the customers, a new stock of the articles need to be replenished at the display areas.

Generally, utility carts are employed for transporting the articles from the storage area to the display area, and thereafter replenishing the display area with the articles. Typically, restocking of the articles is accomplished by employees of the store. The employees usually carry the articles in a utility cart and replenish the shelves with the articles. However, some of the shelves may be located at such an elevated location that it may be inaccessible from an employee's reach. In order to reach such inaccessible elevated locations, the employees utilize a ladder for climbing such elevated location.

Utilizing a ladder for replenishing the articles in the shelves has few disadvantages. Firstly, while transferring the articles from the utility cart to the shelves, the employee may be required to maintain a balance on the ladder. However, due to considerable movement of the customers in the store, it may be very difficult for the employee to maintain balance on the ladder while simultaneously replenishing the articles in the shelves. Secondly, the conventional ladders may be bulky and transporting the bulky ladder every time for reaching inaccessible elevated locations may be an inconvenient exercise for the employee. Also, carrying the ladder along with the utility cart may be equally inconvenient.

Accordingly, there exists a need for apparatus for enabling a user of a utility cart, such as an employee of a store and the like to reach elevated locations and other overhead areas in the store in a convenient manner. Additionally, there exists a need for avoiding a ladder for reaching elevated locations and other overhead areas, thereby providing safety to the users.

### SUMMARY OF THE DISCLOSURE

In view of the foregoing disadvantages inherent in the prior art, the general purpose of the present disclosure is to provide an apparatus that is configured to include all the advantages of the prior art, and to overcome the drawbacks inherent therein.

Accordingly, an object of the present disclosure is to provide an apparatus that enables a user, such as an employee of a retail store to reach elevated locations in a convenient manner.

Another object of the present disclosure is to provide an apparatus that precludes a need of transporting a bulky ladder for reaching elevated locations in a store and the like, thereby avoiding inconvenience associated with transportation of the bulky ladder to the employees of the store.

Yet another object of the present disclosure is to provide an apparatus for accessing elevated locations in a store in a safe, reliable, user friendly, and cost effective manner.

To achieve the above objects, in an aspect of the present disclosure, a step assembly for a utility cart is provided. The disclosed step assembly may be detachably attached to the utility cart. The step assembly includes a platform member and a pair of support legs. The platform member is capable of being hingedly attached to a portion of the utility cart for facilitating movement of the step assembly between an operative position and a collapsed position. The pair of support legs is hingedly attached to the platform member at a peripheral edge portion of the platform member.

In the operative position, the step assembly facilitates a user in reaching elevated locations. Moreover, the step assembly may be made to assume a collapsed position while not being used for reaching elevated locations.

In another aspect of the present disclosure, a coating of an anti-skid material may be provided on a top surface of the platform member. The coating of the anti-skid material ensures safety of the user of the step assembly.

These together with the other aspects of the present disclosure, along with the various features of novelty that characterized the present disclosure, is pointed out with particularity in the claims annexed hereto and forms a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawing, in which:

FIG. 1 illustrates an exploded perspective view of a step assembly, in accordance with an embodiment of the present disclosure;

FIG. 2 illustrates an operative position of the step assembly of FIG. 1 attached to a utility cart, in accordance with an embodiment of the present disclosure; and

FIG. 3 illustrates collapsed view of the step assembly of FIG. 1 attached to the utility cart, in accordance with an embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The terms “a” and “an” herein do not denote a limitation of quantity, but rather denote the presence of at least one of the referenced item.

The present disclosure provides a step assembly for a utility cart, to be used in a store such as a retail store, a grocery store, supermarket, and department store. The retail store, the grocery store, supermarket, and department store may herein after be collectively referred to as a store. The disclosed step assembly may be configured to be removably attached to a utility cart. The step assembly for the utility cart enables a user thereof to reach elevated locations in the store. Example of such elevated locations may include but are not limited to vertically extending shelves in a store that may be located at an elevation inaccessible from user's reach. Accordingly, the present disclosure precludes the need for employing a ladder for reaching elevated locations and other overhead areas in a store. Further, by precluding the need of employing a ladder, the present disclosure saves time and effort spent in reaching elevated locations. The present disclosure is particularly beneficial for employees of the store as the employees are frequently required to reach the high elevation shelves for replenishing the articles therein.

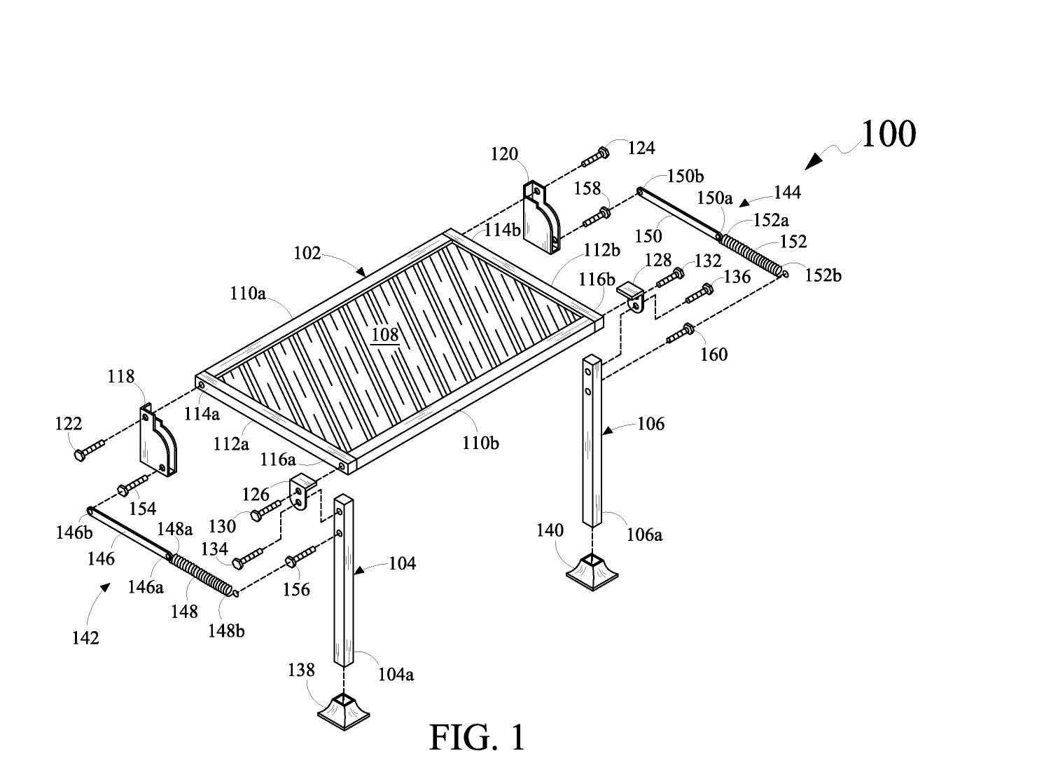

Referring now to FIG. 1, an exploded perspective view of a step assembly 100 is illustrated, in accordance with an embodiment of the present disclosure. The step assembly 100 is capable of being detachably attached to a utility cart (not shown in FIG. 1). The step assembly 100 includes a platform member 102, and a pair of support legs such as a first support leg 104 (hereinafter referred to as leg 104) and a second support leg 106 (hereinafter referred to as leg 106). The leg 104 and the leg 106 may hereinafter collectively be referred to as the pair of support legs 104, 106. The pair of support legs 104, 106 may be hingedly connected to the platform member 102.

In the present embodiment, the platform member 102 is shown and described to assume a rectangular shape, however, it will be evident to a person skilled in the art that the platform member 102 may assume any other shape known in the art, such as a square shape, an oval shape, a round shape, and the like without departing from the scope of the present disclosure. The platform member 102 includes a top surface 108 and a bottom surface (not shown) opposite to the top surface 108. The top surface 108 may be an exposed area to be utilized by the user of the step assembly 100 for stepping thereon in order to reach elevated locations. In an embodiment of the present disclosure, the top surface 108 of the platform member 102 includes a coating of an anti-skid material thereon. The anti-skid material may be a rubber material or any such material known in the art.

The platform member 102 includes a pair of longitudinal edges such as longitudinal edges 110a, 110b, and a pair of lateral edges such as lateral edges 112a, 112b. The lateral edge 112a of the platform member 102 includes a proximal edge portion, such as a proximal edge portion 114a, and a distal edge portion such as a distal edge portion 116a laterally opposite to the proximal edge portion 114a. Similarly, the lateral edge 112b of the platform member 102 includes a proximal edge portion such as a proximal edge portion 114b and a distal edge portion such as a distal edge portion 116b laterally opposite to the proximal edge portion 114b.

The platform member 102 may be hingedly attached to a utility cart by means of an attachment bracket arrangement configured at the proximal edge portions 114a, 114b of the lateral edges 112a, 112b respectively. The attachment bracket arrangement may include a first attachment bracket 118 attached to the proximal edge portion 114a of the lateral edge 112a, and a second attachment bracket 120 attached to the proximal edge portion 114b of the lateral edge 112b. The first attachment bracket 118 and the second attachment bracket 120 may hereinafter collectively be referred to as the pair of attachment brackets 118, 120. In an embodiment of the present disclosure, the first attachment bracket 118 and the second attachment bracket 120 may be attached to the lateral edge 112a and the lateral edge 112b respectively, by means of a fastening member 122 and a fastening member 124 respectively. The attachment bracket arrangement facilitates a pivotal movement of the step assembly 100 about the longitudinal edge 110a.

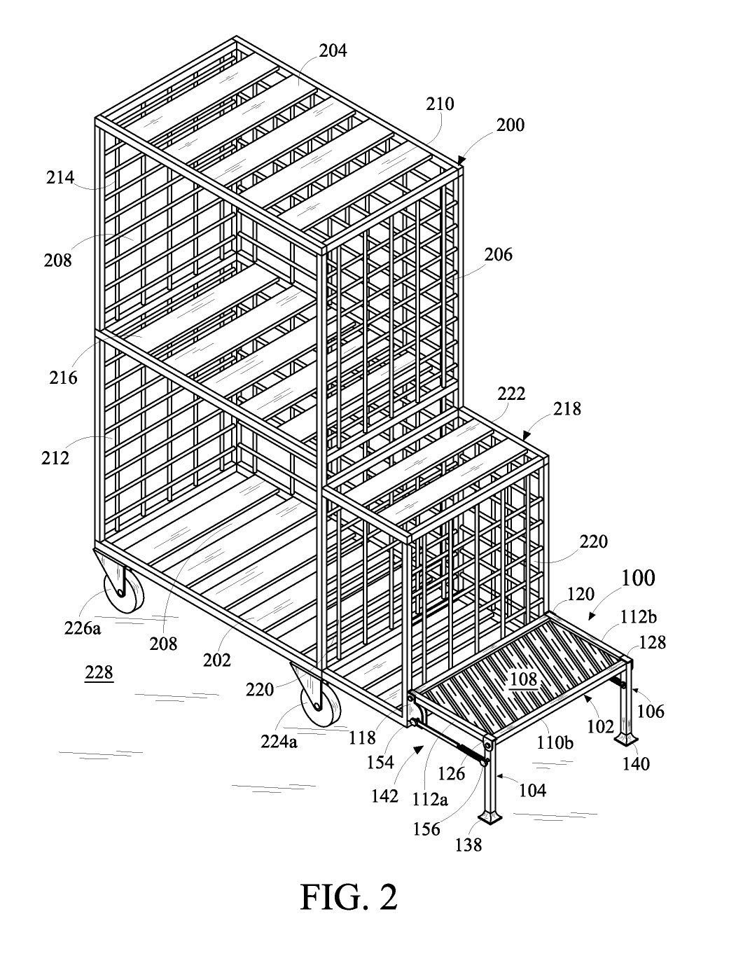

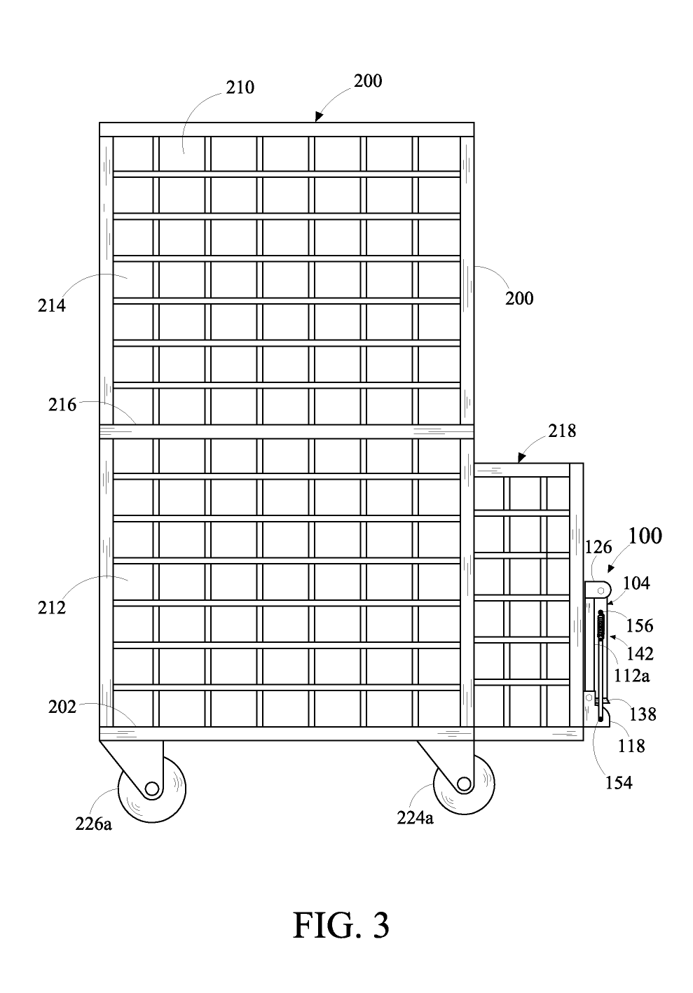

The pair of support legs 104, 106 may be hingedly connected to the platform member 102 by means of a hinge bracket arrangement configured at the distal edge portions 116a, 116b of the lateral edges 112a and 112b. The hinge bracket arrangement may include a first hinge bracket 126 attached to the lateral edge 112a and the leg 104, and a second hinge bracket 128 attached to the lateral edge 112b and the leg 106. The first hinge bracket 126 and the second hinge bracket 128 may hereinafter be collectively referred to as hinge brackets 126, 128. In an embodiment of the present disclosure, the hinge brackets 126, 128 may be attached to the lateral edges 112a, 112b respectively by means of a fastening member 130 and a fastening member 132 respectively. Further, hinge brackets 126, 128 may be attached to the pair of support legs 104, 106 respectively by means of a fastening member 134 and a fastening member 136. The hinge bracket arrangement facilitates a pivotal movement of the pair of support legs 104, 106 about the longitudinal edge 110b. The pivotal movement of the pair of support legs 104, 106 about the longitudinal edge 110b facilitates the movement of the pair of support legs 104, 106 between an open position and a closed position thereof. More specifically, the pivotal movement of the pair of support legs 104, 106 about the longitudinal edge 110b enables the pair of support legs 104, 106 to assume one of an open position and a closed position thereof. The open position and the closed position of the pair of support legs 104, 106 is explained further with reference to FIGS. 2 and 3.

Each of the pair of support legs 104, 106 includes a cap member disposed at a free end thereof. For example, the leg 104 may include a first cap member 138 disposed at a free end 104a of the leg 104, and the leg 106 may include a second cap member 140 disposed at a free end 106a of the leg 106. In an embodiment of the present disclosure, the first cap member 138 and the second cap member 140 may be composed of a slip-resistant material, for example, a rubber material. In an embodiment of the present disclosure, the first cap member 138 and the second cap member 140 are removable from the pair of support legs 104, 106.

The step assembly 100 further includes a pair of connecting members for connecting the pair of support legs, such as pair of support legs 104, 106 to the pair of attachment bracket arrangement. The pair of connecting members facilitates movement of the step assembly 100 between an operative position and a collapsed position. The operative position and the collapsed position of the step assembly 100 are explained in detail with respect to FIGS. 2 and 3.

The pair of connecting members includes a first connecting member 142 and a second connecting member 144 for connecting the pair of support legs 104, 106 to the attachment bracket arrangement. The first connecting member 142 and the second connecting member 144 may hereinafter be collectively referred to as the connecting members 142, 144. Preferably, each of the pair of connecting members are spring loaded having a connecting link attached to a spring member. For example, the first connecting member 142 includes a first connecting link 146 attached to a spring member 148. Further, the second connecting member 144 includes a second connecting link 150 attached to a spring member 152. The spring members, such as the spring members 148, 152 allows the connecting members, such as the connecting members 142, 144 respectively to extend in length for allowing the pair of support legs 104, 106 respectively to suitably move between the open position and the closed position with respect to the platform member 102. As explained herein, the pair of support legs 104, 106 may assume the open position in an operative position of the step assembly 100, and the closed position in the collapsed position of the step assembly 100.

For attaching the first connecting member 142 to the leg 104 and the first attachment bracket 118, a proximal end 148a of the spring member 148 is connected to a distal end 146a of the first connecting link 146, and a distal end 148b of the spring member 148 is connected to the leg 104. Further, a free end or a proximal end 146b of the first connecting link 146 is connected to the first attachment bracket 118 by means of fastening members such as a fastening member 154 which protrudes through mating apertures in the first connecting link 146 and the first attachment bracket 118. The distal end 148b of the spring member 148 is connected to the leg 104 by means of fastening members, such as a fastening member 156 which protrudes through the mating apertures in the leg 104 and the spring member 148.

Similarly, for attaching the second connecting member 144 to the leg 106 and the second attachment bracket 120, a proximal end 152a of the spring member 152 is connected to a distal end 150a of the second connecting link 150 and a distal end 152b of the spring member 152 is connected to the leg 106. Further, a free end or a proximal end 150b of the second connecting link 150 is connected to the second attachment bracket 120 by means of fastening members such as a fastening member 158 which protrudes through mating apertures in the second connecting link 150 and second attachment bracket 120. The distal end 152b of the spring member 152 is connected to the leg 106 by means of fastening members such as a fastening member 160 which protrudes through the mating apertures in the leg 106 and the spring member 152.

FIG. 2 and FIG. 3 depict a step assembly 100 attached to a utility cart 200, in accordance with various embodiments of the present disclosure. More specifically, FIG. 2 depicts an operative position of the step assembly 100 attached to a utility cart 200, in accordance with an embodiment of the present disclosure. FIG. 3 depicts a collapsed view of the step assembly 100 attached to the utility cart 200, in accordance with an embodiment of the present disclosure. In the present description, the step assembly 100 is described in conjunction with the utility cart 200, however it will be understood to a person skilled in the art that the teachings of the present disclosure may be utilized with other carts also without deviating from the scope of the present disclosure.

In an exemplary embodiment, the utility cart 200 includes a framed assembly (not numbered) having multiple compartments therein for storing various articles. The framed assembly includes a bottom panel 202 and a top panel 204, a first front panel 206, a back panel 208, and a side panel 210. The bottom panel 202 and the top panel 204 may be substantially horizontal, while the first front panel 206, the back panel 208, and the side panel 210 may be substantially vertical, thereby collectively configuring a space. The space so configured may be partitioned into various compartments, such as a compartment 212, and a compartment 214 to accommodate various articles therein. In the present embodiment, an intermediate panel 216 may partition the space to configure the compartment 212 and the compartment 214. Further, an auxiliary compartment such as the auxiliary compartment 218 may be configured by a portion of the bottom panel 202, a portion of the first front panel 206, an auxiliary front panel 220 substantially parallel to and spaced apart from the first front panel 206, and an auxiliary side panel 222.

The framed assembly may be supported on a pair of front wheels, such as a wheel 224a, and a pair of rear wheels, such as a wheel 226a. The pair of front wheels and the pair of rear wheels collectively facilitates movement of the utility cart 200 on a substantially plane surface, such as a floor 228. It will be evident to a person skilled in the art that the configuration of the utility cart 200 as described and illustrated herein may be for the illustrative purposes, and it may vary without limiting the scope of the present disclosure.

The step assembly 100 may be attached to a portion of the utility cart 200. The portion of the utility cart 200 may include one of a portion of the first front panel 206, a portion of the back panel 208, a portion of the side panel 210 and the like. In an embodiment of the present disclosure, the step assembly 100 may be attached to a portion of the auxiliary front panel 220 of the utility cart 200, as shown in FIG. 2. The step assembly 100 may be attached to the portion of the auxiliary front panel 220 of the utility cart 200 by means of the pair of attachment brackets 118, 120. The pair of attachment brackets 118, 120 may be adapted to be removably attached to the portion of the auxiliary front panel 220 of the utility cart 200. The removable attachment of the pair of attachment brackets 118, 120 with the portion of the auxiliary front panel 220 may be accomplished by means of any attaching arrangement known in the art, such as a nut-and-bolt arrangement.

In an embodiment of the present disclosure, the pair of attachment brackets 118, 120 may be permanently connected to the portion, such as the auxiliary front panel 220 of the utility cart 200. The permanent attachment of the pair of attachment brackets 118, 120 and the auxiliary front panel 220 of the utility cart 200 may be accomplished by using any technique known in the art, such as wielding.

As explained herein, the pair of attachment brackets 118, 120 are hingedly connected to the platform member 102. The hinged connection facilitates movement of the platform member 102 from an operative position to a collapsed position thereof and vice-versa. The operative position of the platform member 102 is shown in FIG. 2. In the operative position of the step assembly 100, the platform member 102 is positioned substantially parallel to the bottom panel 202. The hinged connection of the leg 104 and the leg 106 with the first hinge bracket 126 and the second hinge bracket 128 respectively facilitates movement of the leg 104 and the leg 106 between the open position and the closed position thereof. In the open position, the leg 104 and the leg 106 are positioned perpendicular to the platform member 102. As, shown in FIG. 3, in the closed position the leg 104 and the leg 106 may be positioned adjacent and parallel to the platform member 102.

In the operative position of the platform member 102, a user of the step assembly 100 may stand on the platform member 102, thereby being elevated in height and thus gaining access to elevated shelves (not shown) and other overhead areas in the retail store. In an embodiment of the present disclosure, the platform member 102 is capable of elevating the height of the user by about 9½ inches.

The movement of the platform member 102 between the operative and the collapsed position is facilitated by the spring members 148, 152. Specifically, while moving from the operative position to the collapsed position, each of the spring members 148, 152 may expand in length, thereby facilitating an unrestricted movement of the platform member 102.

The pair of support legs 104, 106 of the step assembly 100 are suitably dimensioned that when not in use, the pair of support legs 104, 106 may be folded and the step assembly 100 may be collapsed. Specifically, the first connecting member 142 and the second connecting member 144 may lock the pair of support legs 104, 106 in the closed position. The collapsed position of the step assembly 100 is depicted in FIG. 3. In the collapsed position of the step assembly 100, the platform member 102 is positioned proximate and parallel to the auxiliary front panel 220 of the utility cart 200. In the present description, only operative and collapsed positions of the platform member 102 are shown and described. However, it should be evident to a person skilled in the art that the platform member 102 is also capable of assuming a plurality of positions between the operative position and the collapsed position thereof.

As disclosed herein, the step assembly 100 and various elements thereof may be composed of a durable material, such as steel. The step assembly 100 may be designed to include a variety of colors, such as a color matching a color of the utility cart, thereby enhancing an aesthetic appearance thereof.

The present disclosure provides a step assembly such as the step assembly 100 which offers the following advantages. The step assembly includes a platform member such as the platform member 102 which enables a user of the step assembly 100 in reaching elevated locations at shopping facilities such as grocery stores, retail stores, supermarkets, department stores, shopping marts, and the like for retrieving articles from shelves located at elevated locations. The step assembly thereby precludes the need of employing a ladder for reaching elevated locations. Precluding the need of employing a ladder saves time and effort of the user. Moreover, by avoiding the need of transporting a bulky ladder for reaching elevated locations in a store and the like, the disclosed step assembly eliminated inconveniences associated with transportation of the bulky ladder.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A step assembly for a utility cart, the step assembly comprising:
a platform member, the platform member capable of being hingedly attached to a portion of the utility cart for facilitating movement of the step assembly between an operative position and a collapsed position; and
a pair of support legs, the pair of support legs hingedly attached to the platform member at a peripheral edge portion of the platform member.

2. The step assembly of claim 1, wherein the platform member comprises a coating of an anti-skid material on a top surface of the platform member.

3. The step assembly of claim 1, wherein the hinged attachment of the pair of support legs to the peripheral edge portion of the platform member facilitates movement of the pair of support legs between an open position and a closed position of the pair of support legs.

4. The step assembly of claim 3, wherein each support leg of the pair of support legs comprises a connecting member, the connecting member being spring loaded for facilitating movement of the each support leg between the open position and the closed position.

5. The step assembly of claim 1, wherein each support leg of the pair of support legs comprises a cap member disposed at a free end of the each support leg.
